(19) United States
(12) Patent Application Publication
(10) Pub. No.: US 2008/0024713 A1
(43) Pub. Date: Jan. 31, 2008

(54) LIQUID CRYSTAL DISPLAY AND MANUFACTURING METHOD OF THE SAME

(75) Inventors: Kang-woo KIM, Seoul (KR); Seon-ah CHO, Busan (KR); Yoon-sung UM, Yongin-si (KR); Seung-hoo YOO, Seongnam-si (KR); Hee-wook DO, Suwon-si (KR); Hyun-cheol MOON, Seoul (KR); Hye-ran YOU, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/779,598

(22) Filed: Jul. 18, 2007

(30) Foreign Application Priority Data
Jul. 31, 2006 (KR) 10-2006-0072357

(51) Int. Cl. G02F 1/1343

(52) U.S. Cl. 349/144

(57) ABSTRACT

A liquid crystal display includes a first substrate, a second substrate. and a liquid crystal layer disposed between the first substrate and the second substrate. The first substrate includes a first insulating substrate, a plurality of gate lines extending parallel to one another on the first insulating substrate, a plurality of data lines insulated from and crossing the gate lines to define a pixel region, a plurality of first electrode layers formed to be longer in the direction in which the gate lines extend than in the direction in which the data lines extend in the pixel region, and second electrode layers disposed on the gate lines and between the first electrode layers.

### CROSS-REFERENCE TO RELATED APPLICATIONS

This application claims priority from and the benefit of Korean Patent Application No. 10-2006-0072357, filed on Jul. 31, 2006, which is hereby incorporated by reference for all purposes as if fully set forth herein.

### BACKGROUND OF INVENTION

1. Field of the Invention

The present invention relates to a liquid crystal display and a method of manufacturing the same. More particularly, the present invention relates to a liquid crystal display in which a pixel is divided into a plurality of domains to realize a wide viewing angle and a method of manufacturing the same.

2. Discussion of the Background

Liquid crystal displays (LCDs) are widely used as flat panel displays because they are thin, lightweight, and have low power consumption as compared to cathode ray tubes (CRTs).

The LCD controls the orientation of liquid crystals by varying an electric field, which is generated by a potential difference between opposite electrodes, and adjusts the transmittance of light according to the orientation of the liquid crystals, thereby forming an image.

An LCD includes an LCD panel. The LCD panel includes a thin film transistor (TFT) substrate where a gate line, a data line, a TFT, and a pixel electrode are formed. The LCD panel further includes a color filter substrate where a color filter layer and a common electrode are formed and a liquid crystal layer interposed between the two substrates.

Generally, an LCD is driven by a gate on voltage and a gate off voltage that are received alternately and periodically along with a pixel electrode that receives a positive voltage and a negative voltage alternately and periodically. Usually, the gate off voltage has a negative polarity and the gate on voltage has a positive polarity.

In a vertically aligned mode LCD, when the gate line receives the gate off voltage and the pixel electrode receives the negative voltage, the direction of the electric field generated in the gate line is opposite to the direction of a fringe field generated by an opening between the pixel electrodes. Accordingly, the movement of the liquid crystals in a pixel is interrupted and thus, texture that is displayed darkly, due to relatively low transmittance of light, is generated.

### SUMMARY OF THE INVENTION

The present invention provides an LCD that may minimize texture generated when a gate line and a pixel electrode receive voltages with the same polarity and a method of manufacturing the same.

Additional features of the invention will be set forth in the description which follows, and in part will be apparent from the description, or may be learned by practice of the invention.

The present invention discloses a liquid crystal display including a first substrate, a second substrate, and a liquid crystal layer disposed between the first substrate and the second substrate. The first substrate includes a first insulating substrate, a plurality of gate lines extending parallel to one another on the first insulating substrate, a plurality of data lines insulated from and crossing the gate lines to define a pixel region, a plurality of first electrode layers formed to be longer in the direction in which the gate lines extend than in the direction in which the data lines extend and disposed in the pixel region, and second electrode layers disposed on the gate lines between the first electrode layers.

The present invention also discloses a liquid crystal display including a liquid crystal layer, a plurality of gate lines extending parallel to one another, a plurality of data lines insulated from and crossing the gate lines to define a pixel region, and an electrode layer. The electrode layer includes a plurality of pixel electrodes formed to be longer in the direction in which the gate lines extend than in the direction in which the data lines extend in the pixel region, and a shield is disposed between the pixel electrodes and corresponding to the gate lines.

The present invention also discloses a method of manufacturing a liquid crystal display, including forming a plurality of gate lines on a substrate forming a plurality of data lines on the gate lines to be insulated from and cross the gate lines to define a pixel region, forming a plurality of first electrode layers to be longer in the direction in which the gate lines extend than in the direction in which the data lines extend, and forming second electrode layers between the first electrode layers to cover the gate lines.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a common electrode in an arrangement view of a TFT substrate according to an exemplary embodiment of the present invention.

FIG. 2 is a sectional view taken along line II-II′ in FIG. 1.

FIG. 3 is a sectional view taken along line III-III′ in FIG. 1.

FIG. 4 shows a second electrode layer according to an exemplary embodiment of the present invention.

FIG. 5A, FIG. 5B, and FIG. 5C show the generation of texture in a pixel which is adjacent to a gate line.

FIG. 6A, FIG. 6B, and FIG. 6C show the decreasing effect of texture in an LCD according to an exemplary embodiment of the present invention.

FIG. 7A, FIG. 7B, and FIG. 7C show a method of manufacturing the LCD according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

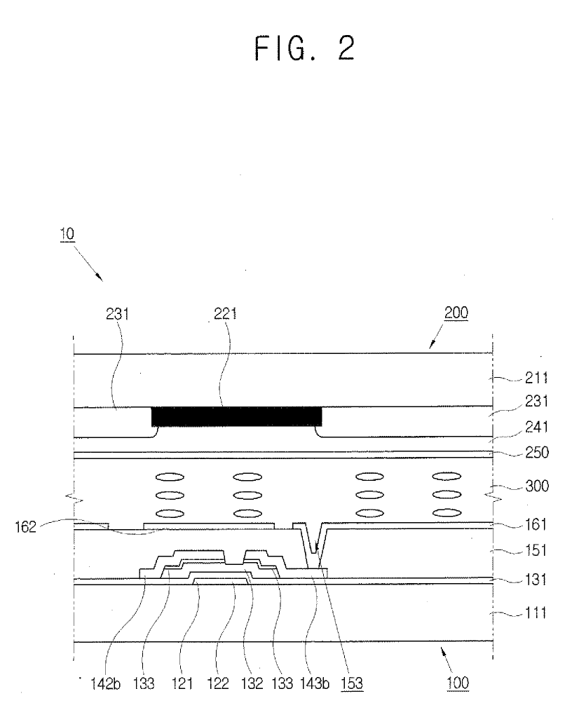

Referring to FIG. 2, an LCD panel 10 according to a first exemplary embodiment of the present invention includes a TFT substrate (first substrate) 100, a color filter substrate (second substrate) 200 facing the TFT substrate 100, and a liquid crystal layer 300 interposed between the two substrates.

To begin, the TFT substrate 100 will be described below.

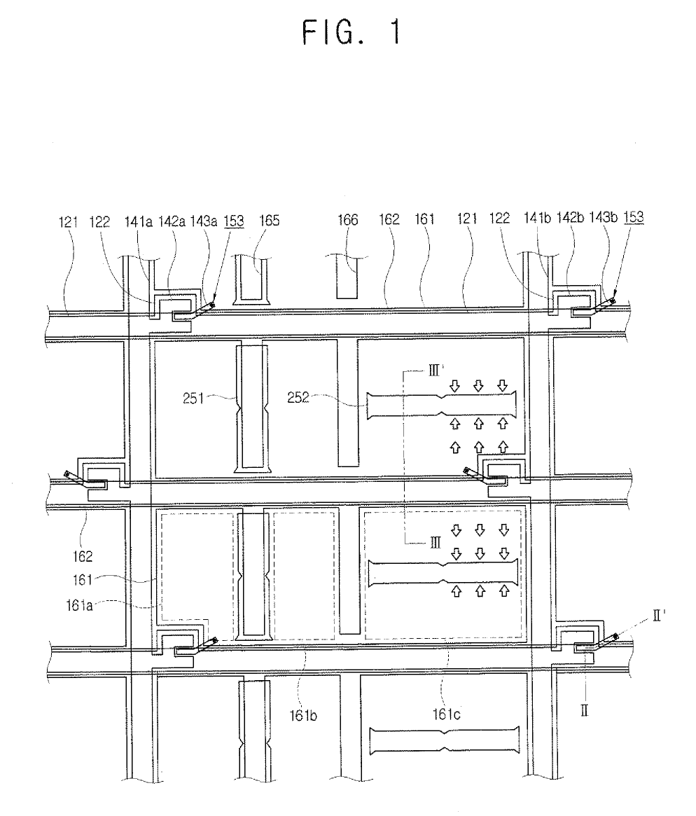

Referring to FIG. 1 and FIG. 2, a plurality of gate wires 121 and 122 are formed on a first insulating substrate 111. The gate wires 121 and 122 may include a metal, and they may have a single or multi-layered structure. The gate wires 121 and 122 include gate lines 121 extending transversely and gate electrodes 122 protruding from the gate lines 121 to form part of a TFT. The gate lines 121 are disposed under a second electrode layer 162 (mentioned later) in the region of the second electrode layer 162.

A gate insulating layer 131 may be made of silicon nitride (SiNx) or the like and is formed on the first insulating substrate 111 to cover the gate wires 121 and 122.

A semiconductor layer 132 may be made of amorphous silicon or the like and is formed on the gate insulating layer 131 over the gate electrode 122. An ohmic contact layer 133 may be made of n+ hydrogenated amorphous silicon, which is highly doped with silicide or n-type impurities, and formed on the semiconductor layer 132. The ohmic contact layer 133 is excluded in a channel region between a source electrode 142b and a drain electrode 143b.

A plurality of data wires 141a, 141b, 142a, 142b, 143a, and 143b are formed on the ohmic contact layer 133 and the gate insulating layer 131. The data wires comprise first data wires 141a, 142a, and 143a and second data wires 141b, 142b, and 143b, which are disposed parallel to each other and have a first electrode layer 161 disposed there between. The data wires 141a, 141b, 142a, 142b, 143a, and 143b may include a metal, and they may have a single or multi-layered structure. The data wires 141a, 141b, 142a, 142b, 143a, and 143b include data lines 141a and 141b formed longitudinally and crossing the gate lines 121 to define a pixel region, source electrodes 142a and 142b protruding from the data lines 141a and 141b to extend over the ohmic contact layer 133, and drain electrodes 143a and 143b separated from the source electrodes 142a and 142b and formed on the ohmic contact layer 133 opposite the source electrodes 142a and 142b.

Referring to FIG. 2, a passivation layer 151 is formed on the data wires 141a, 141b, 142a, 142b, 143a, and 143b and a portion of the semiconductor layer 132, which is not covered with the data wires. A contact hole 153 is formed in the passivation layer 151 to expose the drain electrodes 143a and 143b. The passivation layer 151 may be made of an inorganic material, such as SiNx, SiO2, or the like, or may be an organic material.

The electrode layers 161 and 162 are formed on the passivation layer 151. The electrode layers 161 and 162 include the first electrode layer 161 formed in a pixel region and the second electrode layer 162 formed along and corresponding to the gate lines 121, which are arranged between the first electrode layers 161. The electrode layers 161 and 162 may be made of a transparent conductive material such as indium tin oxide (ITO) or indium zinc oxide (IZO). The first electrode layer 161 and the second electrode layer 162 may be made of the same material and may be manufactured at the same time.

The first electrode layer 161 is a pixel electrode in a nearly rectangular shape, which is longer in the direction in which the gate lines 121 extend. Referring to FIG. 1, three neighboring first electrode layers 161 in the direction in which the data lines 141a and 141b extend form one pixel, i.e., a first pixel electrode, a second pixel electrode, and a third pixel electrode form a pixel. The first electrode layers 161 in one pixel are connected to different gate lines 121, respectively.

The first electrode layers 161 disposed in the direction in which the data lines 141a and 141b extend are alternately connected to a first data line 141a and a second data line 141b. The first electrode layers 161 in one pixel are driven sequentially. In a conventional LCD, three first electrode layers in one pixel are disposed in the direction in which a gate line extends and are connected to the same gate line. In the present embodiment, the number of the gate lines 121 required to operate the same number of pixels is tripled and the number of data lines 141a and 141b required is decreased by one third. (The gate lines 121 triple in number and the data lines 141a and 141b decrease in number by one third to realize the same number of pixels.)

Each first electrode layer 161 is provided as a single body, but is divided into a plurality of domains by a first pixel cutting part 165 and a second pixel cutting part 166, which are formed in the first electrode layer 161. The first pixel cutting part 165 and the second pixel cutting part 166 are formed parallel to the first data line 141a and the second data line 141b, and the first data line 141a is disposed closer to the first pixel cutting part 165 than the second pixel cutting part 166. Accordingly, the first electrode layer 161 is divided into a first domain 161a disposed between the first data line 141a and the first pixel cutting part 165, a second domain 161b disposed between the first pixel cutting part 165 and the second pixel cutting part 166, and a third domain 161c disposed between the second pixel cutting part 166 and the second data line 141b. The first electrode layer 161 is connected to the drain electrodes 143a and 143b through the contact hole 153.

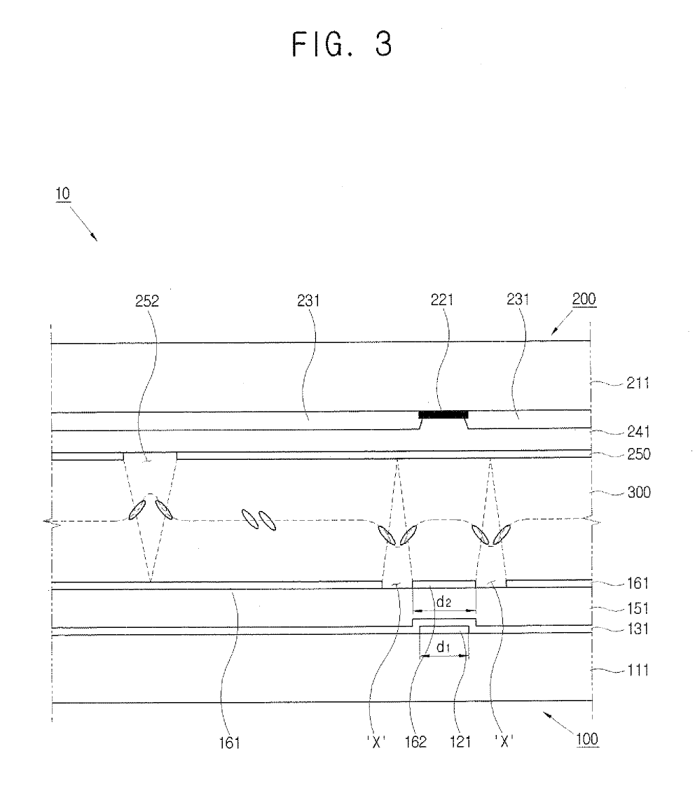

Referring to FIG. 1, FIG. 2, and FIG. 3, a plurality of second electrode layers 162 are formed on the gate lines 121 and between the first electrode layers 161. The second electrode layers 162 are formed along the gate lines 121 and cover the gate lines 121. That is, the second electrode layers 162 are provided for the gate lines 121 to be disposed within a region of the second electrode layers 162, and the width d2 of the second electrode layers 162 is equal to or larger than the width d1 of the gate lines 121. For example, the width d2 of the second electrode layers 162 may be provided to be 1 μm to 4 μm wider than the width d1 of the gate lines 121. The second electrode layers 162 are provided as a shield to block an electric field generated in the gate lines 121 and, more specifically, to weaken the intensity of the electric field generated in the gate lines 121 that flows into the liquid crystal layer 300. The principle that the second electrode layers 162 weaken the intensity of the electric field generated in the gate lines 121 will be explained below.

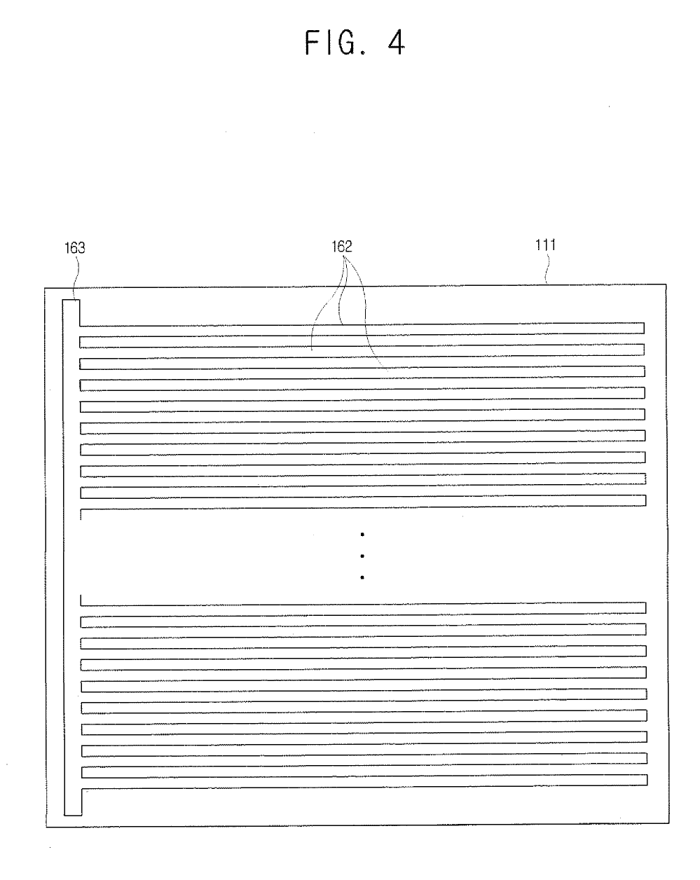

In an exemplary embodiment as shown in FIG. 4, the second electrode layers 162 are connected to a connecting part 163. The second electrode layers 162 receive the same voltage through the connecting part 163. That is, the connecting part 163 receives a voltage from and supplies the voltage to the plurality of second electrode layers 162. The connecting part 163 is disposed at an edge of the first insulating substrate 111 where an image is not formed.

Next, the color filter substrate 200 will be described below.

Referring to FIG. 2 and FIG. 3, a black matrix 221 is formed on a second insulating substrate 211. The black matrix 221 is disposed between red, green, and blue filters to divide the filters, and prevents light from being irradiated directly to the TFT disposed on the first substrate 100. The black matrix 221 may be made of a photoresist organic material including a black pigment. The black pigment may include carbon black, titanium oxide, or the like.

A color filter layer 231 comprises red, green, and blue filters which are alternately disposed and separated by the black matrix 221. The color filter layer 231 endows colors to light irradiated from a backlight unit (not shown) and passing through the liquid crystal layer 300. The color filter layer 231 may be made of a photoresist organic material.

An overcoat layer 241 may be formed on the color filter layer 231 and the black matrix 221. The overcoat layer 241 protects the color filter layer 231 and provides a flat surface. The overcoat layer 241 may be made of an acrylic epoxy material.

A common electrode 250 is formed on the overcoat layer 241. The common electrode 250 may be made of a transparent conductive material, such as ITO or IZO, and applies voltage to the liquid crystal layer 300 along with the first electrode layers 161 on the first substrate 100. The common electrode 250 includes common electrode cutting parts 251 and 252. The common electrode cutting parts 251 and 252 divide the liquid crystal layer 300 into a plurality of domains along with the first and second pixel cutting parts 165 and 166 of the first electrode layers 161. The common electrode cutting parts 251 and 252 formed on the common electrode 250 include a first common electrode cutting part 251 corresponding to the first pixel cutting part 165 and a second common electrode cutting part 252 formed in a direction transverse to the direction in which the second pixel cutting part 166 extends and corresponding to the third domain 161c.

The liquid crystal layer 300 is disposed between the first substrate 100 and the second substrate 200. The liquid crystal layer 300 may be in a vertically aligned (VA) mode, where liquid crystal molecules are aligned perpendicular to the substrates 100 and 200 in a lengthwise direction under a voltage-off state between the substrates 100 and 200. The liquid crystal molecules with negative dielectric anisotropy are oriented perpendicular to an electric field in a voltage-on state. However, if the first and second pixel cutting parts 165 and 166 and the first and second common electrode cutting parts 251 and 252 are not formed, the orientation of the liquid crystal molecules is not determined. Accordingly, the liquid crystal molecules may be randomly arranged and show a disclination line. The first and second pixel cutting parts 165 and 166 and the first and second common electrode cutting parts 251 and 252 generate a fringe field when voltage is applied to the liquid crystal layer 300, thereby determining the orientation of the liquid crystal molecules. Also, the liquid crystal layer 300 is divided into a plurality of domains depending on the arrangement of the first and second pixel cutting parts 165 and 166 and the first and second common electrode cutting parts 251 and 252.

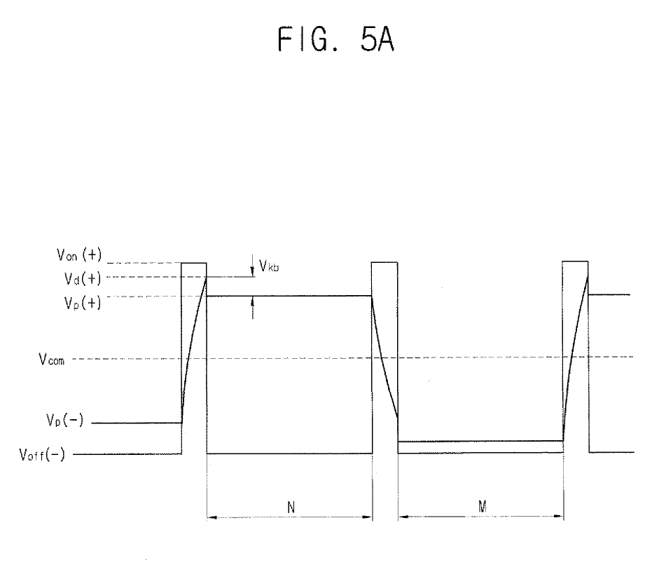

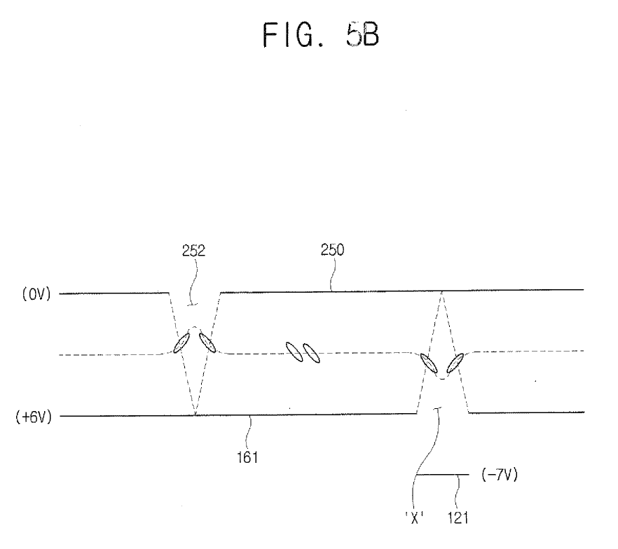

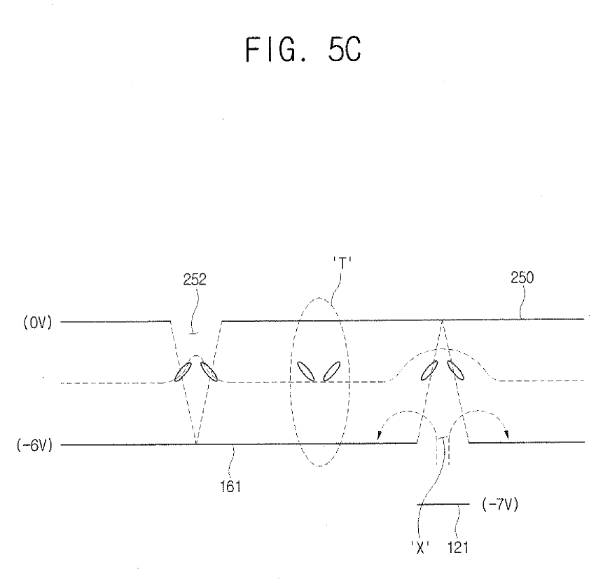

Hereinafter, the generation of texture and a principle of decreasing the texture in the LCD according to the present embodiment will be described with reference to drawings. FIG. 5A shows the result of a simulation when a single gate on voltage is applied and schematically shows variations on voltages of one gate line 121 and one first electrode layer 161 in a plurality of frames.

As described above, the gate lines 121 and the first and second data lines 141a and 141b provided on the first substrate 100 cross with each other to define the pixel region, and the first electrode layers 161 are connected to the TFTs, respectively. Referring to FIG. 5A, the plurality of gate lines 121 sequentially receive the gate on voltage Von to turn on the TFTs connected to the gate lines 121. When the TFTs are turned on, a data voltage Vd applied through the data lines 141a and 141b is charged to the first electrode layers 161, that is a pixel electrode. Namely, the first electrode layers 161 receiving a positive data voltage Vd(+) are provided with a positive gate on voltage Von(+), and the first electrode layers 161 receiving a negative data voltage Vd(−) are provided with a negative gate on voltage Von(−). The data voltage Vd, referring to FIG. 5A, may be applied with variations in polarity for the frames.

Here, the data voltage Vd applied to the first electrode layers 161 drops because of parasitic capacitance between the gate electrodes 122 and the source electrodes 142a and 142b, thereby forming a pixel voltage Vp. The voltage difference between the data voltage Vd and the pixel voltage Vp is called the kickback voltage Vkb.

FIG. 5B is a sectional view showing the orientation of the liquid crystal molecules when the first electrode layers 161 receive voltages having different polarities under the same conditions as in FIG. 5C. In detail, in FIG. 5B, the common electrode 250 receives a voltage Vcom of 0V, the first electrode layers 161 receive a voltage Vp of +6V, and the gate lines 121 receive a voltage Voff of −7V. In FIG. 5C, the pixel voltage Vp, which is applied to the first electrode layers 161, is changed into −6V. That is, FIG. 5B is a sectional view of the common electrode 250, the first electrode layers 161, and the gate lines 121 in section N of FIG. 5A, and FIG. 5C is a sectional view of the same in section M of FIG. 5A.

As shown in FIG. 5B, when the gate lines 121 and the first electrode layers 161 receive voltages having different polarities, the fringe field formed by the common electrode cutting part 252 and the opening between the first electrode layers 161 has the same direction as the electric field of the gate lines 121 and, therefore, may not generate the texture in the liquid crystal layer 300.

However, as shown in FIG. 5C, when the gate lines 121 and the first electrode layers 161 receive voltages having the same polarity, the electric field of the gate lines 121 extends in a direction opposite that of the fringe field formed by the opening between the first electrode layers 161. Accordingly, the movement of the liquid crystals in the first electrode layers 161 is interrupted, and thus, texture that is displayed dark, due to relatively low transmittance of light in part ‘T,’ is generated.

In order to reduce the texture generated when the gate lines 121 and the first electrode layers 161 receive voltages having the same polarity, the second electrode layers 162 are further formed on the gate lines 121 to block the electric field of the gate lines 121 in the present embodiment. Accordingly, the intensity of the electric field flowing into the liquid crystal layer 300 may be reduced by the second electrode layers 162, and thus, the fringe field and the electric field extend in the same direction, thereby decreasing the texture. In other words, the liquid crystal molecules in one pixel are aligned in the direction of the arrows shown in FIG. 1, which may minimize interruption between the liquid crystal molecules. Accordingly, the transmittance of light may be improved and the texture decreases.

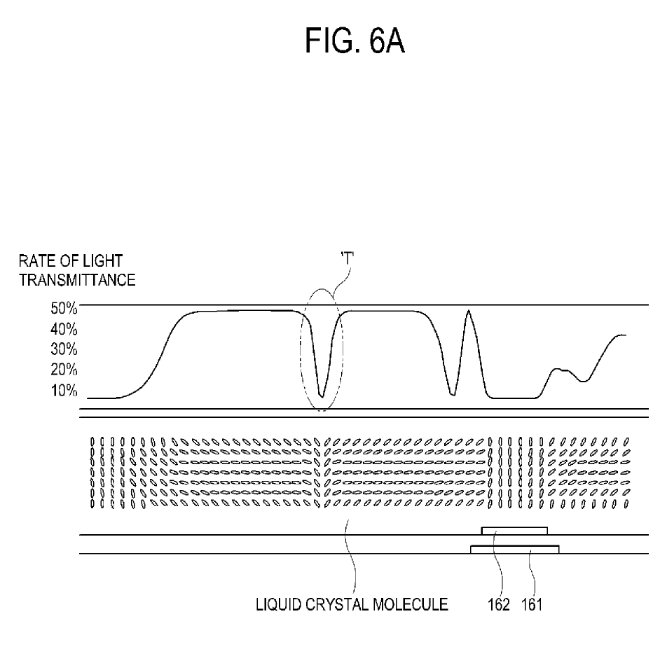

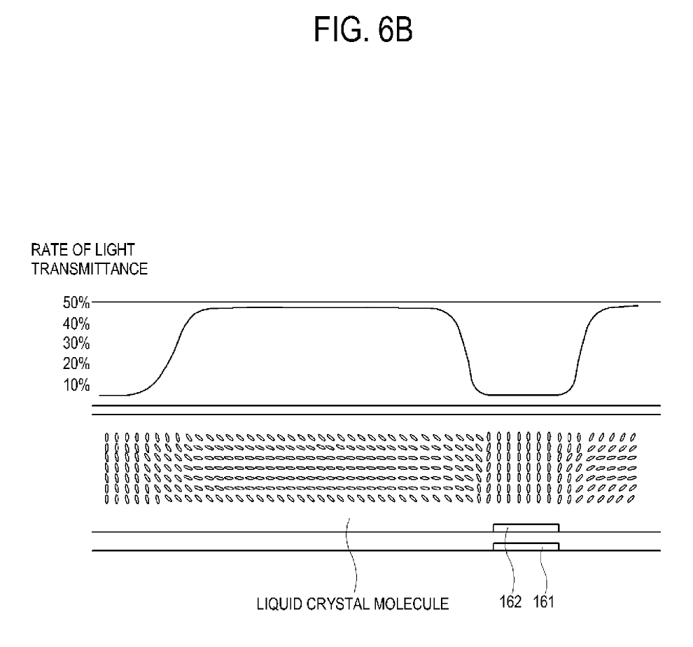

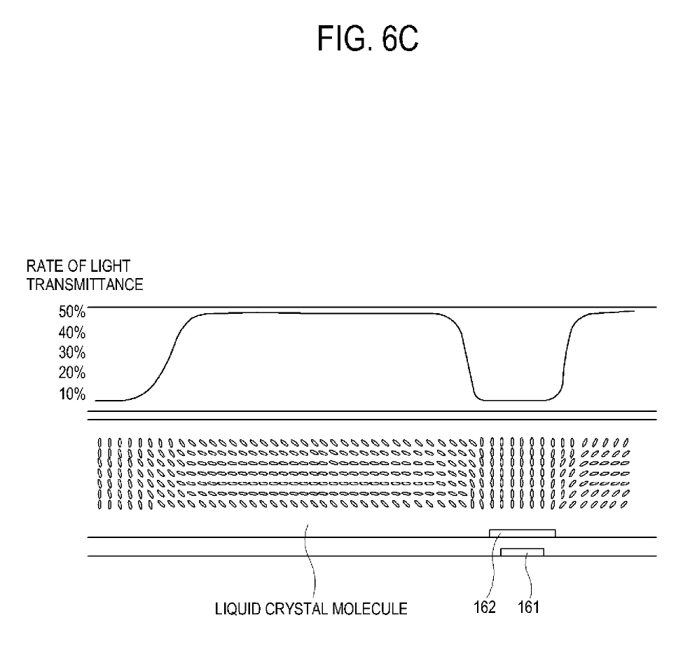

Hereinafter, an effect of decreasing the texture will be described with reference to FIG. 6A, FIG. 6B, and FIG. 6C. FIG. 6A, FIG. 6B, and FIG. 6C show sectional views of the orientation of the liquid crystal molecules in the liquid crystal layer 300 in the lower part and the transmittance of the light in the upper part. FIG. 6A shows a case where the width d2 of the second electrode layers 162 is smaller than the width d1 of the gate lines 121, FIG. 6B shows a case where the width d2 is equal to the width d1, and FIG. 6C shows a case where the width d2 is larger than the width d1.

Referring to FIG. 6A, when the width d2 of the second electrode layers 162 is smaller than the width d1 of the gate lines 121, the second electrode layers 162 do not efficiently block the electric field generated in the gate lines 121 to generate the texture T. The transmittance of light decreases in a region where the texture is generated.

Referring to FIG. 6B, when the width d2 of the second electrode layers 162 is equal to the width d1 of the gate lines 121, the second electrode layers 162 block the electric field generated in the gate lines 121, which decreases generation of the texture. Referring to FIG. 6C, when the width d2 of the second electrode layers 162 is larger than the width d1 of the gate lines 121, the width where the transmittance of light is low decreases as compared with that in the FIG. 6B. That is, the generation of texture may be avoided and the transmittance of light may be improved.

Thus, the second electrode layers 162 may have an equal or larger width than the gate lines 121. The second electrode layers 162 may be formed 1 μm to 4 μm wider than the gate lines 121, considering a blocking effect due to misalignment of the first substrate 100 and the second substrate 200.

Hereinafter, a method of manufacturing the LCD according to the present embodiment will be described. More specifically, a method of manufacturing the TFT substrate with the second electrode layers will be described in the following.

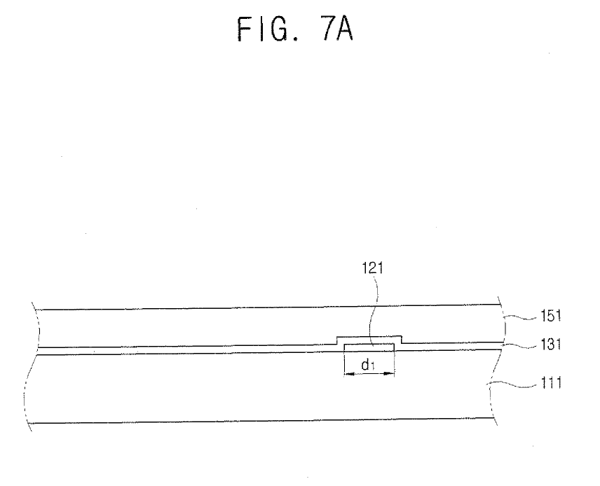

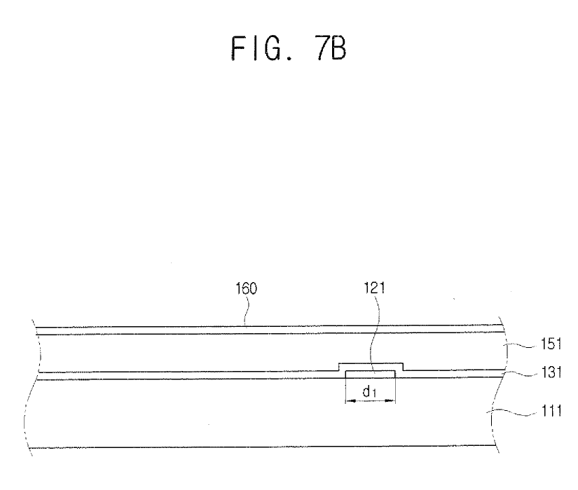

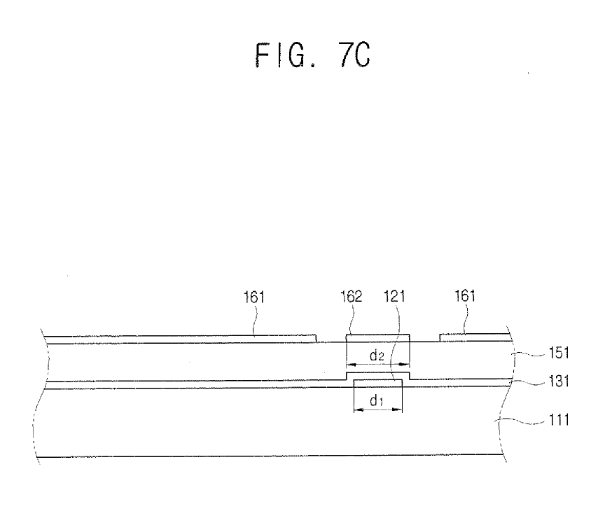

Referring to FIG. 7A, the gate lines 121 with a predetermined width d1, the gate insulating layer 131 to cover the gate lines 121, and the passivation layer 151 to cover the gate insulating layer 131 are formed on the first insulating substrate 111.

Referring to FIG. 7B, a conductive material is arranged on the passivation layer 151 to form a conductive material layer 160. The conductive material may be a transparent conductive metal oxide such as ITO or IZO. The conductive material may be formed on the passivation layer 151 by sputtering.

Referring to FIG. 7C, the conductive material layer 160 is patterned to simultaneously form the first electrode layers 161 and the second electrode layers 162. The conductive material layer 160 may be patterned by photolithography or etching. The second electrode layers 162 may be formed to cover the gate lines 121 so that the electric field generated in the gate lines 121 is efficiently blocked. Further, the width d2 of the second electrode layers 162 may be equal to or larger than the width d1 of the gate lines 121 to improve the transmittance of the light, thereby reducing the texture. The first electrode layers 161 include the first pixel cutting part 165 (see FIG. 1) and the second pixel cutting part 166 (see FIG. 1) to divide the first electrode layers 161 into a plurality of domains The first pixel cutting part 165 and the second pixel cutting part 166 are formed when the conductive material layer 160 is patterned.

As described above, according to exemplary embodiments of the present invention, it may be possible to provide an LCD that minimizes the texture generated when a gate line and a pixel electrode receive voltages having the same polarity in a VA mode, as well as a method of manufacturing the same.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display, comprising:
a first substrate;
a second substrate; and
a liquid crystal layer disposed between the first substrate and the second substrate, the first substrate comprising:
a first insulating substrate;
a plurality of gate lines extending parallel to one another on the first insulating substrate;
a plurality of data lines insulated from and crossing the gate lines to define a pixel region;
a plurality of first electrode layers formed to be longer in the direction in which the gate lines extend than in the direction in which the data lines extend, the first electrode layers being disposed in the pixel region; and
second electrode layers disposed on the gate lines and between the first electrode layers.

2. The liquid crystal display of claim 1, wherein the second electrode layers are disposed along the gate lines and cover the gate lines.

3. The liquid crystal display of claim 2, wherein the width of the second electrode layers is equal to or larger than the width of the gate lines.

4. The liquid crystal display of claim 3, wherein the width of the second electrode layers is 1 μm to 4 μm larger than the width of the gate lines.

5. The liquid crystal display of claim 3, wherein the first electrode layers and the second electrode layers are disposed on the same layer.

6. The liquid crystal display of claim 5, further comprising a connecting part arranged substantially parallel to the data lines, wherein the second electrode layers extend from the connecting part.

7. The liquid crystal display of claim 6, wherein the first electrode layers comprise a first pixel electrode, a second pixel electrode, and a third pixel electrode which together form one pixel, and the first pixel electrode, the second pixel electrode, and the third pixel electrode are connected to different gate lines from each other.

8. The liquid crystal display of claim 7, wherein two pixel electrodes among the first pixel electrode, the second pixel electrode, and the third pixel electrode are connected to the same data line.

9. The liquid crystal display of claim 7, wherein the first pixel electrode, the second pixel electrode, and the third pixel electrode are sequentially driven.

10. The liquid crystal display of claim 7, wherein a first pixel cutting part and a second pixel cutting part are disposed in the respective pixel electrodes to divide the pixel electrodes into a plurality of domains.

11. The liquid crystal display of claim 10, wherein the data lines comprise a first data line and a second data line disposed parallel to each other, the first electrode layers being disposed there between,
the first pixel cutting part and the second pixel cutting part are disposed parallel to the first data line and the second data line, and
the first pixel cutting part is disposed between the first data line and the second pixel cutting part, wherein the first pixel electrode, the second pixel electrode, and the third pixel electrode each comprise a first domain disposed between the first data line and the first pixel cutting part, a second domain disposed between the first pixel cutting part and the second pixel cutting part, and a third domain disposed between the second pixel cutting part and the second data line.

12. The liquid crystal display of claim 11, wherein the second substrate comprises a common electrode, and the common electrode comprises a first common electrode cutting part disposed corresponding to the first pixel cutting part and a second common electrode cutting part disposed in a direction transverse to the direction in which the second pixel cutting part extends and corresponding to the third domain.

13. The liquid crystal display of claim 12, wherein the liquid crystal layer comprises liquid crystal molecules in a vertically aligned mode.

14. A liquid crystal display, comprising:
a liquid crystal layer;
a plurality of gate lines extending parallel to one another;
a plurality of data lines insulated from and crossing the gate lines to define a pixel region; and
an electrode layer including a plurality of pixel electrodes formed to be longer in the direction in which the gate lines extend than in the direction in which the data lines extend in the pixel region, and a shield disposed between the pixel electrodes and corresponding to the gate lines.

15. The liquid crystal display of claim 14, wherein the shield decreases the intensity of an electric field generated in the gate lines.

16. The liquid crystal display of claim 15, wherein the width of the shield is equal to or larger than the width of the gate lines.

17. The liquid crystal display of claim 15, wherein the shield extends along the gate lines and covers the gate lines.

18. The liquid crystal display of claim 17, wherein the pixel electrodes and the shield comprise the same material.

19. A method of manufacturing a liquid crystal display, comprising:
forming a plurality of gate lines on a substrate;
forming a plurality of data lines on the gate lines to be insulated from and cross the gate lines to define a pixel region;
forming a plurality of first electrode layers to be longer in the direction in which the gate lines extend than in the direction in which the data lines extend; and
forming second electrode layers between the first electrode layers to cover the gate lines.

20. The method of claim 19, wherein the width of the second electrode layers is equal to or larger than the width of the gate lines.

21. The method of claim 20, wherein the first electrode layers and the second electrode layers are simultaneously formed.

22. The method of claim 20, wherein the first electrode layers comprise a first pixel cutting part and a second pixel cutting part which divide the first electrode layers into a plurality of domains, and the second electrode layers are formed simultaneously with the first pixel cutting part and the second pixel cutting part are formed.
